(19) United States
(12) Patent Application Publication
(10) Pub. No.: US 2024/0297465 A1
(43) Pub. Date: Sep. 5, 2024

(54) OUTER CONDUCTOR CONTACT FOR A CONNECTOR AND CONNECTOR

(71) Applicant: MD Elektronik GmbH, Waldkraiburg (DE)

(72) Inventors: Rudolf WIEBE, Kraiburg am Inn (DE); Stefan BLASI, Wurmsham (DE)

(21) Appl. No.: 18/443,394

(22) Filed: Feb. 16, 2024

(30) Foreign Application Priority Data
Mar. 3, 2023 (DE) 10 2023 105 261.6

(51) Int. Cl. H01R 24/40; H01R 9/05; H01R 13/627

(52) U.S. Cl. CPC H01R 24/40; H01R 9/05; H01R 13/6277

(57) ABSTRACT

An outer conductor contact for a connector includes an elongated hollow body with a plug-in side for mating with a mating connector. An elevation or depression extends at least partially in a circumferential direction on an outer surface of the hollow body. At least one angular recess or projection is arranged at least partially on a side of the elevation or depression facing away from the plug-in side.

### CROSS REFERENCE TO RELATED APPLICATION

This application claims benefit to German Patent Application No. DE 10 2023 105 261.6, filed on Mar. 3, 2023, which is hereby incorporated by reference herein.

### FIELD

The invention relates to an outer conductor contact for a connector and to a connector, where the connector preferably comprises a coaxial connector.

### BACKGROUND

Coaxial connectors are known in the prior art. No distinction is made here between conventional coaxial systems and mini-coaxial systems. In a coaxial connector, the contacts of the inner and outer conductor(s) are arranged and fixed in a housing. In particular, the fixation is done by means of an undercut, such as a snap-in hook, which holds an outer conductor contact of a connected coaxial cable in the housing. The snap-in hook secures the outer conductor contact in the housing, in particular under tensile load on the coaxial cable.

In practice, outer conductor contacts with a large (outer) radius can be manufactured with process reliability and are gentle on the material. However, large radii of the outer conductor contacts reduce the pull-off forces, i.e. the outer conductor contact is released from the housing more quickly under tensile load on the coaxial cable. This is unfavorable for the durability and reliability of the coaxial connector. Smaller radii of the outer conductor contacts increase the pull-off forces, but are more difficult to manufacture. In summary, it can be said that unfavorable radii occur in the area of the contact surface on the snap-in hook due to the manufacturing process of the outer conductor contact.

### SUMMARY

In an embodiment, the present invention provides an outer conductor contact for a connector. The outer conductor contact includes an elongated hollow body with a plug-in side for mating with a mating connector. An elevation or depression extends at least partially in a circumferential direction on an outer surface of the hollow body. At least one angular recess or projection is arranged at least partially on a side of the elevation or depression facing away from the plug-in side.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a perspective view of an embodiment of an outer conductor contact;

FIG. 2 a side view of the embodiment of the outer conductor contact of FIG. 1; and

FIG. 3 a perspective view of an embodiment of a connector.

### DETAILED DESCRIPTION

Embodiments of the present invention provide to increase the reliability of a connector.

In particular, the increased reliability of a connector is provided according to an embodiment of the present invention by an outer conductor contact for a connector comprising an elongated hollow body having a plug-in side for mating with a mating connector, an elevation or depression extending at least partially in a circumferential direction on an outer surface of the hollow body, and at least one angular recess or an angular projection arranged at least partially on a side of the elevation or depression facing away from the plug-in side.

In the outer conductor contact according to an embodiment of the present invention, the elevation or depression serves to fix the outer conductor contact in a housing of a connector. In particular, a stop side of the elevation or depression can be brought into contact with a snap-in hook on the housing when the outer conductor contact is in a mounted state in the housing. In the event of a tensile load on the connected (coaxial) cable, the snap-in hook prevents the outer conductor contact from detaching from the housing and/or from being pulled out. Due to the angular recess or projection, the elevation or depression thereby has points, which, due to their small surface area and/or edge(s), cause greater pressure. If a (coaxial) cable connected to the outer conductor contact is subjected to a tensile load, i.e. with a force away from the outer conductor contact, a higher compressive load acts in the area of the at least one edge on the recess or projection, which leads at least to a stronger frictional connection between outer conductor contact and snap-in hook. In particular, a form fit can also occur between the outer conductor contact and the snap-in hook. The stronger frictional connection and/or the form fit at least makes it more difficult for the snap-in hook to slip over the elevation or out of the depression, so that the pull-off forces increase significantly.

Preferably, the elongated hollow body has a cylindrical shape. The cylindrical shape creates radial symmetry, which is particularly advantageous for high-frequency (HF) data transmission.

Preferably, the at least one angular recess comprises a hole or slot. Holes or slots can easily be made in the outer conductor contact at any time and with any dimensions. Thus, an outer conductor contact can be optimally adapted to a particular snap-in hook and/or a particular housing.

Preferably, the at least one edge of the angular recess or projection has an interior angle in the range of 70-100 degrees, more preferably in the range of 85-95 degrees. The acute or hyper acute interior angles create sharp edges. Sharp edges are particularly suitable for effecting a form fit with the snap-in hook.

Preferably, the outer conductor contact comprises a hard electrically conductive material, preferably a metal or metal compound. Due to its hardness, the outer conductor can join with or to the snap-in hook in a dimensionally stable manner. The dimensional stability does not change the predetermined product properties.

The increased reliability of a connector is provided according to a further embodiment of the present invention by a connector comprising a housing with at least one plug-in position for an outer conductor contact, at least one snap-in hook arranged at each plug-in position, and at least one outer conductor contact, wherein in an assembled state, the at least one angular recess or the at least one angular projection of the at least one outer conductor contact abuts against the at least one snap-in hook.

The connector according to an embodiment of the present invention is suitable to be connected or mated with a suitable mating connector to form an HF or coaxial plug-in connection for data forwarding. Since the present outer conductor contact, when arranged in a connector housing, has increased pull-off forces (under tensile load), the connector is more reliable overall.

Preferably, the snap-in hook comprises a malleable material, preferably plastic. Due to the malleable material, the angular recess or the angular projection at the outer conductor contact can create a form fit with the snap-in hook under tensile load on the cable. In particular, an edge of the angular recess or angular projection can work itself into or press into the snap-in hook during tensile load on the cable so that the snap-in hook does not slip over the elevation or out of the depression. Thus the pull-off forces are significantly increased.

Preferred embodiments are described in detail below with reference to the accompanying figures.

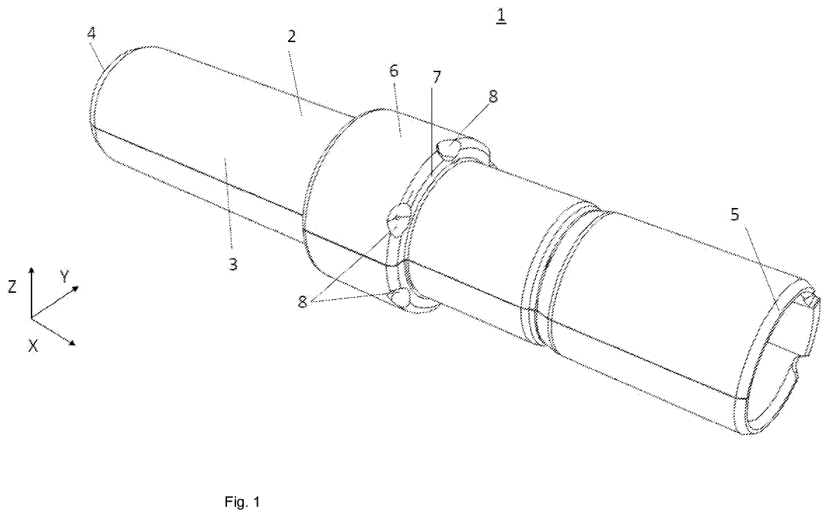

FIG. 1 shows an embodiment of an outer conductor contact 1 for a connector 10, in particular for a coaxial connector 10. The outer conductor contact 1 shown has an elongated hollow body 2, in particular with a cylindrical shape. At one end along an axial direction X, the outer conductor contact 1 has a plug-in side 4 for mating with a mating connector. At the opposite end, the outer conductor contact 1 has a cable outlet side 5, to which a (coaxial) cable can be joined or connected. The outer conductor contact 1 is configured to make electrical contact with the outer conductor of the (coaxial) cable.

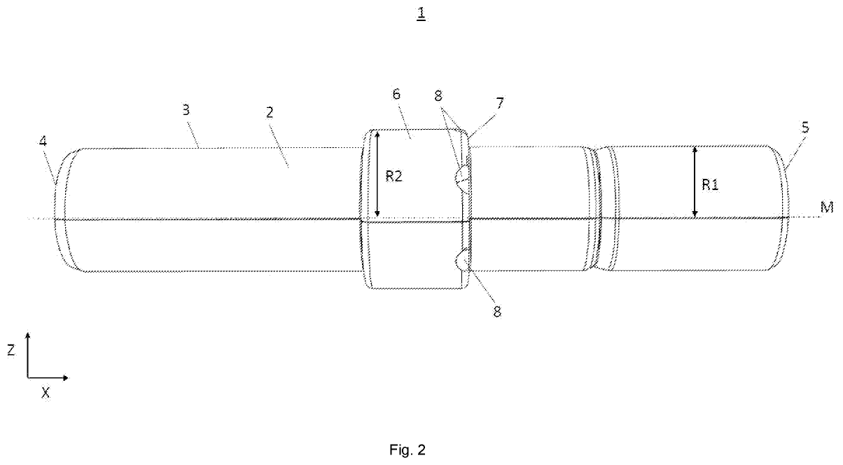

Furthermore, the outer conductor contact 1 has an elevation or depression 6. An elevation 6 is shown in the figures. The elevation 6 has a larger second outer radius R2 than the hollow body 2 with the first outer radius R1, measured from a central or longitudinal axis M (see FIG. 2). The elevation 6 extends at least partially in the circumferential direction Y-Z, i.e. along the second and/or third direction Y, Z transverse to the axial or longitudinal direction X, on an outer surface 3 of the hollow body 2. The elevation 6 forms a stop surface 7, which can abut against a separate (upper) surface, such as a snap-in hook 13.

At least one angular recess or projection 8 is formed at the stop surface 7, or as shown in FIGS. 1 and 2, at the transition between the stop surface 7 and an outer peripheral surface of the elevation 6. In the embodiment shown, at least three angular recesses 8 are formed. In alternative embodiments, the number may be different. In alternative embodiments, a mixture of angular recesses and angular projections 8 may also be formed. It is important that the angular recesses and/or projections 8 are at least partially arranged on a side of the elevation or depression 6 facing away from the plug-in side 4, so that the angular recesses and/or projections 8 come into direct contact with the separate (upper) surface, against which the stop surface 7 rests in the assembled state when a force is applied in the direction of the cable outlet side 5.

In the embodiment shown, the angular recesses 8 are formed as holes. In alternative embodiments, the angular recesses 8 may also comprise other shapes, such as slots. Preferably, the angular recesses 8 have sharp edges, i.e. edges having an interior angle in the range of 70-100 degrees, more preferably in the range of 85-95 degrees.

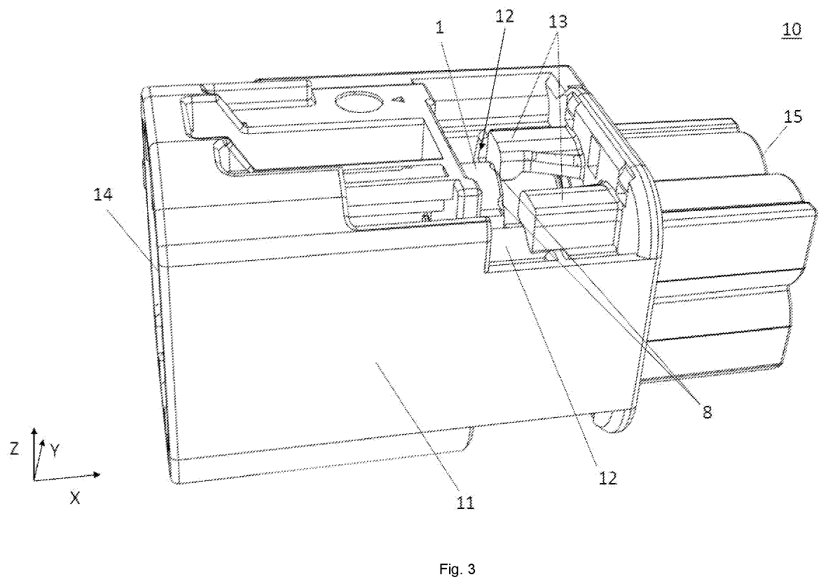

FIG. 3 shows an embodiment of a connector 10, in particular a coaxial connector 10. The connector 10 has a housing 11 with at least one plug-in position 12 for an outer conductor contact 1. In the embodiment shown, the connector 10 has a total of four plug-in positions 12 for arranging four outer conductor contacts 1. Each of these four plug-in positions 12 has at least one snap-in hook 13. Each snap-in hook 13 serves to fix the respective outer conductor contact 1 in the respective plug-in position 12.

For a simplified presentation only one outer conductor contact 1 is arranged in a plug-in position 12 of the housing 11 in FIG. 3. The outer conductor contact 1 shown is in an assembled state, with the snap-in hook 13 fixing the outer conductor contact 1 and preventing it from moving unintentionally in the direction of the cable outlet side 15. In particular, at least one angular recess 8 of the at least one outer conductor contact 1 rests against the snap-in hook 13. In practice, a small gap may be present between the outer conductor contact 1 and the snap-in hook 13 for tolerance reasons, whereby the gap is closed immediately when the cable is subjected to the tensile load described.

If a force is applied to the connected cable in the direction of the cable outlet side 15, the outer conductor contact 1 exerts a pressure on the snap-in hook 13, in particular with its stop surface 7. Thereby, due to the recesses 8, wherein at least one recess 8 is in contact with the snap-in hook 13, an increased frictional connection is formed between the outer conductor contact 1 and the snap-in hook 13 than without the recesses 8. Preferably, the outer conductor contact 1 comprises a hard electrically conductive material, in particular a metal or a metal compound, and the snap-in hook 13 is formed from a malleable material, preferably plastic, so that the outer conductor contact 1 is pressed or punched into the snap-in hook 13 under load and thereby creates a form fit between outer conductor contact 1 and snap-in hook 13. Thus, the snap-in hook 13 can no longer slip over the second radius R2 of the elevation 6. The result is a (coaxial) connector with improved reliability.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 outer conductor contact
2 hollow body
3 surface
4 plug-in side
5 cable outlet side
6 elevation
7 stop surface
8 recess
10 connector
11 housing
12 plug-in position
13 snap-in hook
14 plug-in side
15 cable outlet side
M central axis
R1 first radius
R2 second radius
X axial direction
Y second direction
Z third direction

What is claimed is:

1. An outer conductor contact for a connector, the outer conductor contact comprising:
an elongated hollow body with a plug-in side for mating with a mating connector;
an elevation or depression extending at least partially in a circumferential direction on an outer surface of the hollow body; and
at least one angular recess or projection arranged at least partially on a side of the elevation or depression facing away from the plug-in side.

2. The outer conductor contact according to claim 1, wherein the elongated hollow body has a cylindrical shape.

3. The outer conductor contact according to claim 1, wherein the at least one angular recess comprises a hole or slot.

4. The outer conductor contact according to claim 1, wherein the at least one edge of the angular recess or the angular projection has an interior angle in a range of 70 to 100 degrees.

5. The outer conductor contact according to claim 4, wherein the interior angle is in a range of 85 to 95 degrees.

6. The outer conductor contact according to claim 1, wherein the outer conductor contact comprises a hard electrically conductive material.

7. The outer conductor contact according to claim 6, wherein the hard electrically conductive material is a metal or a metal compound.

8. A connector, comprising:
a housing with at least one plug-in position for an external conductor contact;
at least one snap-in hook arranged at each plug-in position; and
at least one outer conductor contact comprising:
an elongated hollow body with a plug-in side for mating with a mating connector;
an elevation or depression extending at least partially in a circumferential direction on an outer surface of the hollow body; and
at least one angular recess or projection arranged at least partially on a side of the elevation or depression facing away from the plug-in side,
wherein, in an assembled state, the at least one angular recess or the at least one angular projection of the at least one outer conductor contact rests against the at least one snap-in hook.

9. The connector according to claim 8, wherein the snap-in hook comprises a malleable material.

10. The connector according to claim 9, wherein the malleable material is a plastic.
